(19) United States
(12) Patent Application Publication
(10) Pub. No.: US 2003/0101084 A1
(43) Pub. Date: May 29, 2003

(54) Method and system for allocating a budget surplus to a task

(76) Inventor: Clara Maria Otero Perez, Eindhoven (NL)

Correspondence Address: U.S. Philips Corporation, 580 White Plains Road, Tarrytown, NY, 10591, US

(21) Appl. No.: 10/294,530

(22) Filed: Nov. 14, 2002

(30) Foreign Application Priority Data
Nov. 19, 2001 (EP) 01204415.2

(51) Int. Cl. G06F 17/60

(52) U.S. Cl. 705/8; 705/30

(57) ABSTRACT

Media processing in software can be used for consumer terminals like digital television sets or set-top boxes. For reasons of cost-effectiveness, the average processor utilization must be high. This is mostly achieved by allocating below worst-case processor budgets to tasks performing media processing operations. Only if a stable output quality is a primary requirement, a task gets allocated a worst-case processor budget. To gain back on the cost-effectiveness in such a situation, a method and a system are provided to reallocate an unused part of a budget (212) from a first task (τₘ) with a worst-case budget to a second task (τₚ) with a below worst-case budget. The second task (τₚ) may then use the resulting budget surplus (216) to improve the quality of its output. The method and system operate at a very low level, in the scheduling of the tasks performing the media processing. What effectively happens is that the second task (τₚ) gets executed in the place of the first task (τₘ), as if it were the first task (τₘ), with scheduling characteristics such as period and priority of the first task (τₘ).

The invention relates to a method of scheduling a first task and a second task, the method comprising the following steps:

a first step of allocating a first budget to the first task,

a second step of allocating a second budget to the second task,

a third step of determining that the first task uses up only part of the first budget, with the remaining part of the first budget giving rise to a budget surplus,

a fourth step of reallocating the budget surplus to the second task, in addition to the second budget.

The invention also relates to a system for scheduling a first task and a second task, the system comprising:

first allocation means conceived to allocate a first budget to the first task,

second allocation means conceived to allocate a second budget to the second task,

determination means conceived to determine that the first task uses up only part of the first budget, with the remaining part of the first budget giving rise to a budget surplus,

reallocation means conceived to reallocate the budget surplus to the second task, in addition to the second budget.

Media processing in software enables consumer terminals to become open and flexible. At the same time, consumer terminals are heavily resource-constrained, because of a high pressure on costprice. To be able to compete with dedicated hardware solutions, media processing in software has to use the available resources very cost-effectively, with a high average resource utilization, while preserving typical qualities of consumer terminals, such as robustness, and meeting stringent timing requirements imposed by high-quality digital audio and video processing. An important resource in this respect is the media processor used for performing the media processing operations.

Media processing in software makes it possible to use dynamically scalable applications, trading resources for quality. At run-time, a Quality of Service (QoS) resource manager can adapt the quality levels at which the applications execute, so as to maximize the perceived quality of the combined application outputs, given the available resources. A central concept in the QoS resource management is the notion of a resource budget assigned to an application. To address dynamic behavior at different time scales, the QoS resource manager is conceived as a multilevel structure. The higher levels determine and adjust quality levels and resource budgets to maximize perceived output quality. At the lowest level, a budget scheduler provides, guarantees and enforces the allocated resource budgets. In the case of a processor, this will typically entail an allocation of processor capacity to application tasks. Thus, the higher levels of the QoS resource manager build their policies on a mechanism provided by a lower level. The adjustment of quality levels and resource budgets is based on measurements and on feedback control between the QoS resource manager and all of the applications concerned. However, because of these interactions, such adjustments cannot be done without delay.

In a situation where a stable quality level is a primary QoS requirement for an application, a resource budget allocated to it must be large enough to accommodate an anticipated load increase. In this way, whenever this load increase occurs, it can be accommodated without delay. However, in a fully loaded terminal, a higher resource budget can only be obtained by giving a smaller budget to other applications. Furthermore, as long as the load increase does not occur, a higher resource budget results in a budget surplus, reducing the cost-effectiveness. To gain back on the cost-effectiveness, a mechanism is needed to conditionally reallocate the budget surplus to the other applications. This involves modifications at the level of the budget scheduler.

For the allocation of processor capacity to tasks, the budget scheduler uses a scheduling algorithm. This is a set of rules that determine the task to be executed by the processor at a particular moment. The budget scheduler uses a scheduling algorithm that provides the notion of a processor capacity budget, assigned to a task. Budgets are periodic, and the budget period may be different for each task. The budget scheduler builds upon a more basic scheduling algorithm to provide the notion of a periodic budget. Basic scheduling algorithms for an environment such as considered here are described in, for example, Liu and Layland, Scheduling Algorithms for Multiprogramming in a Hard Real-Time Environment (Journal of the Association for Computing Machinery, Volume 20, Number 1, pages 46 to 61). These scheduling algorithms are pre-emptive and priority driven. This means that, whenever there is a request for executing a task that is of a higher priority than the one currently being executed, the running task is immediately interrupted and the newly requested task is started. Thus, the specification of such algorithms amounts to the specification of the method of assigning priorities to tasks. A scheduling algorithm is said to be static if priorities are assigned to tasks once and for all. A static scheduling algorithm is also called a fixed priority scheduling algorithm. With respect to achievable processor utilization, it can be shown that the rate-monotonic priority assignment is optimal for a fixed priority assignment rule. A scheduling algorithm is said to be dynamic if priorities of tasks might change from request to request. A well-known dynamic scheduling algorithm is the deadline driven scheduling algorithm. With this algorithm, priorities are assigned to tasks according to the deadlines of their current requests. A scheduling algorithm is said to be a mixed scheduling algorithm if the priorities of some of the tasks are fixed and the priorities of the remaining tasks vary from request to request. Unused processor capacity is often called slack time. It results from tasks not completely consuming their budgets, from imperfections in the scheduling used, or from unused processor capacity. Improving the cost-effectiveness means that the slack time must be minimized. In practice, the presence of some slack time will be unavoidable. At a low priority, a task can potentially receive some slack time. This is called execution in the background. Given that budgets assigned to tasks are generally below worst-case to be cost-effective, tasks may have problems in the case of very transient budget overloads. A limited amount of slack time may now even be useful to resolve most of these overload situations.

An embodiment of a method and a system of the kind set forth above and as defined in the preamble of claim 1 is known from Bril and Steffens, User Focus in Consumer Terminals and Conditionally Guaranteed Budgets (Proceedings 9-th International Workshop on Quality of Service, Lecture Notes in Computer Science 2092, pages 107 to 120). Here a budget scheduler is implemented on top of a real-time operating system providing pre-emptive priority-based scheduling. The budget scheduler schedules processor capacity and provides guaranteed periodic budgets to tasks. This guarantee is based on an admission test that checks the feasibility of scheduling a set of budgets, and an enforcement mechanism that prevents tasks from interfering with the budgets of other tasks. Budgets are implemented by means of priority manipulations. In-budget execution is performed at a high priority, and out-of-budget execution is done at a low priority. Budgets are periodic, and the budget period may be different for each task. For the in-budget execution, the tasks are scheduled in rate-monotonic priority order, such that a task with a smaller budget period gets a higher priority. This gives rise to a high-priority band for in-budget execution. Priorities of tasks are disjoint in the high-priority band. At the start of each new period, the priority of a task is raised to its rate-monotonic priority within the high-priority band. When the budget of a task is exhausted, or when the task releases the processor, the priority of the task is lowered to the low priority. At the low priority, a task can potentially receive some slack time for execution in the background. The admission test of the budget scheduler is based on rate monotonic analysis.

For the known method and system, reallocation of a budget surplus from one task to another task is done by means of an additional middle-priority band, situated below the high-priority band and above the low priority. A task receiving a budget surplus from another task receives the budget surplus after it has exhausted its own budget. At that instant, instead of immediately lowering the priority of the receiving task to the low priority, it is first lowered to a priority in the middle-priority band. The budget surplus is now provided at this intermediate priority. When the budget surplus is exhausted, or when the task releases the processor, the priority of the task is lowered to the low priority. A drawback of this usage of an additional middle-priority band is that it may easily lead to a non-rate monotonic priority assignment. In general, such a priority assignment yields a non-optimal solution that conflicts with the high average resource utilization aimed for. It may even preclude an effective reallocation of the budget surplus altogether.

It is an object of the invention to provide a method as set forth above that reallocates a budget surplus in an improved way. To achieve this object, the method according to the invention is characterized in that the fourth step comprises a sub-step of:

allocating the budget surplus to the second task together with scheduling characteristics of the first task.

What effectively happens with this sub-step is that the second task gets executed in the place of the first task, as if it were the first task, with scheduling characteristics such as period and priority of the first task. The budget surplus expresses the processor capacity that was not needed by the first task and that should now become available to the second task. The scheduling characteristics of a task express the characteristics of the task with respect to the scheduling algorithm that is used.

For the known method and system, the budget scheduler uses fixed priority scheduling as the basic scheduling algorithm, with tasks scheduled in rate-monotonic priority order. In that case, the scheduling characteristics of a task amount to a budget period and a fixed priority in the high-priority band. Reallocation of the budget surplus together with scheduling characteristics now means that a task eligible for a budget surplus receives the budget surplus with the period and the priority of the task that gave rise to the surplus. Unlike the known reallocation method, the new reallocation method will not affect the rate monotonic priority assignment used, making possible a more optimal solution, in line with the high average resource utilization aimed for. An additional advantage of the new reallocation method is that it does not affect the availability of slack time. The known reallocation method can potentially consume all the slack time available, leaving no slack time for tasks executing in the background. This could affect the behavior of such tasks to the extent that tasks that used to work fine will show problems when the known reallocation method is used. This will not happen with the new reallocation method. Another additional advantage is that no extra priority levels, due to the need for a middle-priority band, are needed with the new reallocation method. Priority levels should be used sparingly, given that, in general, operating systems provide only a relatively limited number of them.

For a budget scheduler that uses dynamic priority scheduling with earliest deadline first as the basic scheduling algorithm, the scheduling characteristics of a task amount to a budget period and a deadline. Reallocation of the budget surplus together with scheduling characteristics now means that a task eligible for a budget surplus receives the budget surplus with the period and the deadline of the task that gave rise to the surplus.

The system according to the invention is characterized in that the reallocation means comprises:

third allocation means conceived to allocate the budget surplus to the second task together with scheduling characteristics of the first task.

The invention will be described more in detail by means of embodiments shown in the following drawings:

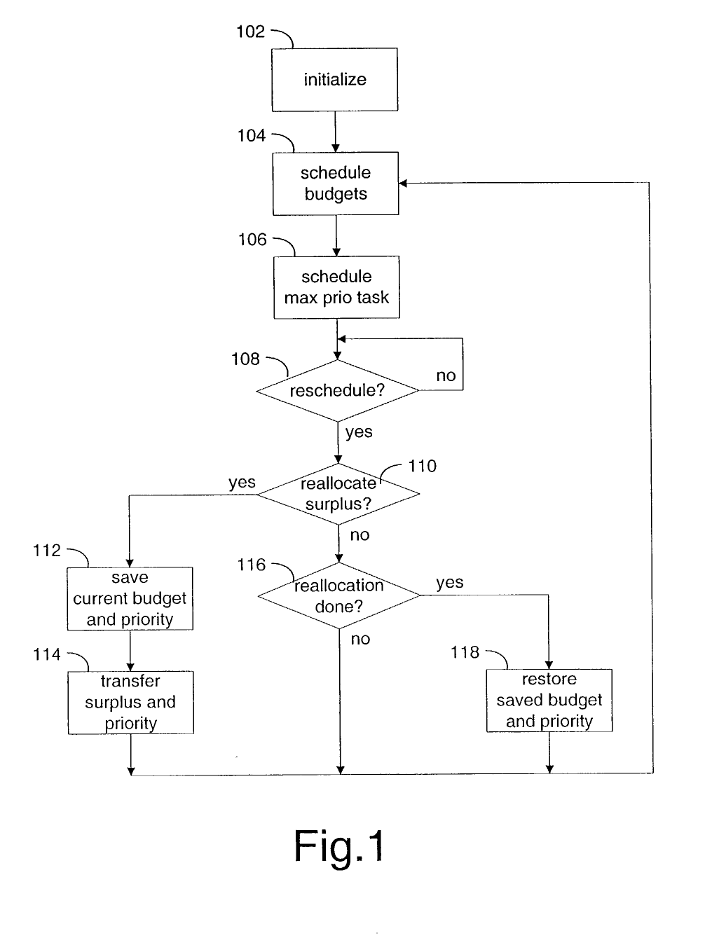

FIG. 1 illustrates an embodiment of the main steps of the method according to the invention that reallocates a budget surplus from a first task to a second task,

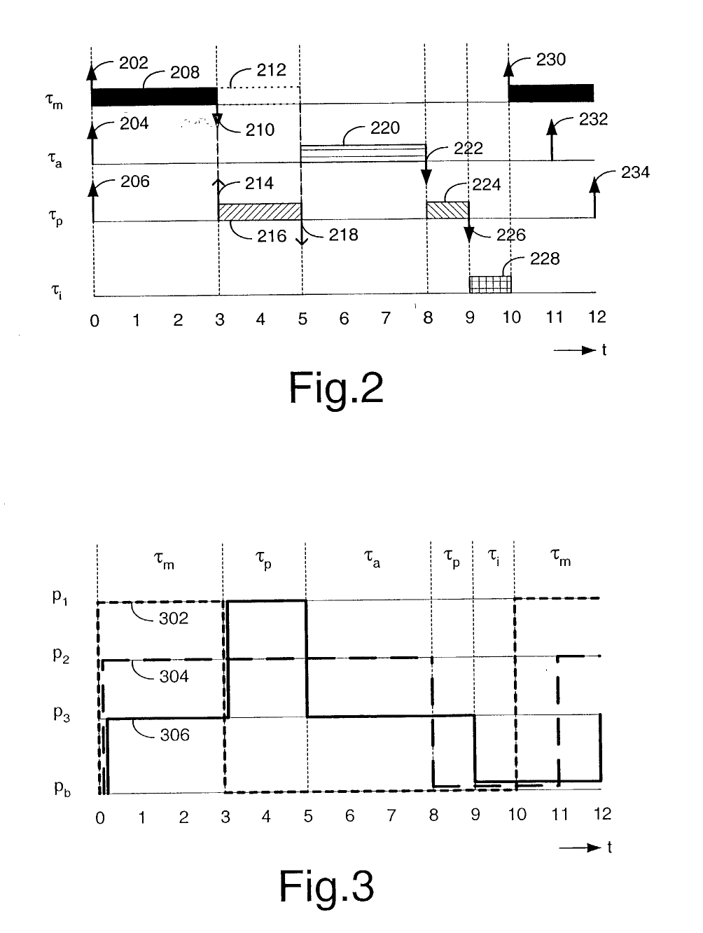

FIG. 2 illustrates with a task interaction diagram the reallocation of a budget surplus,

FIG. 3 illustrates with a priority level diagram the reallocation of a budget surplus,

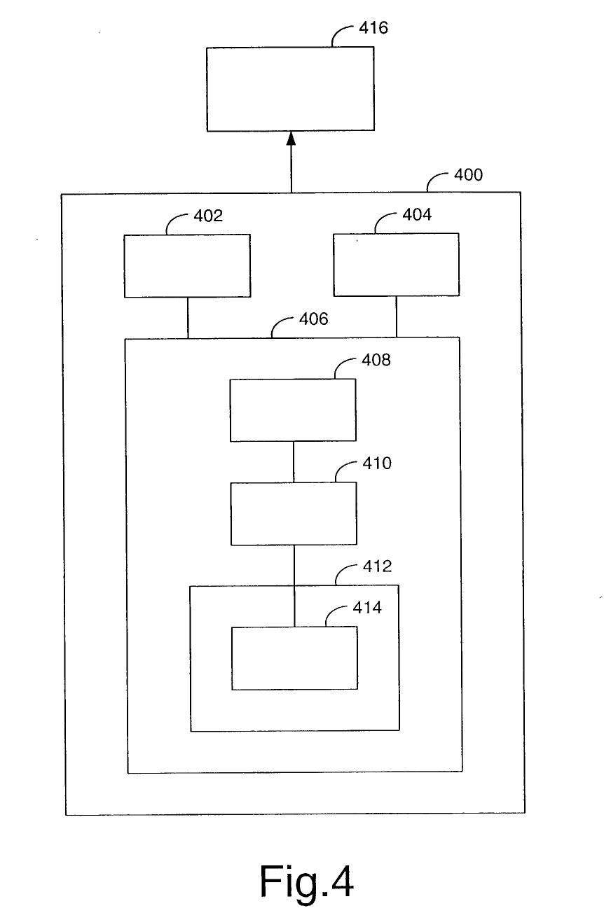

FIG. 4 illustrates, in a schematic way, the most important parts of an embodiment of the system according to the invention,

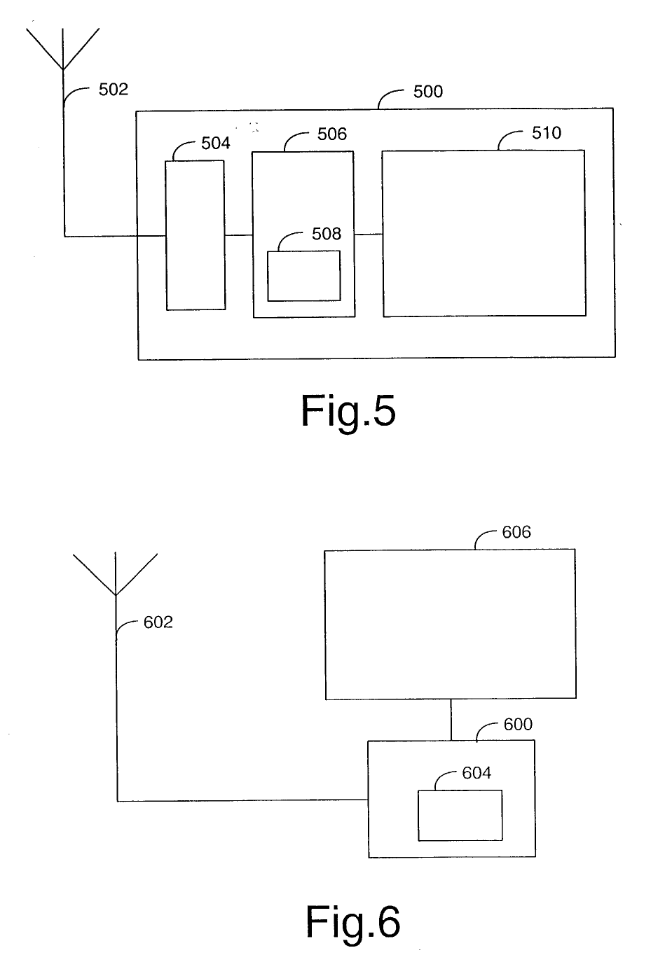

FIG. 5 illustrates, in a schematic way, the most important parts of a television set that comprises an embodiment of the system according to the invention,

FIG. 6 illustrates, in a schematic way, the most important parts of a set-top box that comprises an embodiment of the system according to the invention.

FIG. 1 illustrates an embodiment of the main steps of the method according to the invention that reallocates a budget surplus from a first task to a second task. For high-quality video systems, a QoS resource manager allocates processor capacity budgets to tasks that perform audio and video processing. The budgets are periodic, and the budget period may be different for each task. The QoS resource manager allocates the budgets for a longer interval of time, encompassing many periods. For reasons of cost-effectiveness, the budgets must result in a high average processor utilization, while at the same time maximizing the perceived quality of the combined task outputs. In a situation where a stable output quality level is required, a budget that allows an anticipated load increase is allocated to a task. In this way, whenever such a load increase occurs, it can be handled without delay. Such a task, say τₘ, performs, for example, a video processing operation for a main picture image of a television set. In this case, a stable output quality level means a stable picture quality. A second task, say τₚ, performs, for example, a video processing operation for a picture-in-picture image of this television set. Unlike task τₘ, this task has a less stringent requirement for a stable picture quality. Still, to maximize the perceived quality, this task receives any budget surplus from task τₘ whenever available. In this way, task τₚ may be able to improve on the quality of the picture-in-picture image whenever task τₘ does not require its full budget. There may be more tasks, performing other processing operations. For example, a third task, say τₐ, may perform an audio processing operation. These tasks may not need a budget that allows an anticipated load increase and they may neither benefit from any budget surplus from some other task.

The scheduling of the tasks can be done as described in the main steps below. Process step 102 is an initialization step during which the tasks to be scheduled are given their periodic budgets and are made known to a budget scheduler. The budget scheduler is part of the QoS resource manager and controls the actual scheduling operations, based on the periodic budgets. It is implemented on top of a commercially available real-time operating system providing pre-emptive fixed priority-based scheduling. The budget scheduler uses priority manipulations to implement budgets. In-budget execution is performed at a high priority, and out-of-budget execution is done at a low, background priority p_{b}. For the in-budget execution, the tasks are scheduled in rate-monotonic priority order, such that a task with a smaller budget period gets a higher priority. Priorities of tasks are disjoint for in-budget execution. At the background priority p_{b}, a task can potentially receive some slack time for execution in the background, competing for this time with any other tasks executing at this priority. As part of process step 102, the budget scheduler associates an in-budget priority to each of the tasks to be scheduled, based on the budged period of a task. For example, in the case of the tasks τₘ, τₐ, and τₚ introduced above, this may be the priorities p₁, p₂, and p₃, respectively, where p₁>p₂>p₃. Thus, task τₘ, performing the main picture processing operation, has the highest priority p₁, task τₚ, performing the picture-in-picture processing operation, has the lowest priority p₃, and task τₐ, performing the audio processing operation has a priority p₂ in between. All of these priorities are higher than the background priority p_{b}.

In process step 104, the budget scheduler enforces the budgets of all tasks. This step is entered repeatedly, whenever rescheduling operations are needed. One reason for a rescheduling operation may be a task that enters a new, next budget period. This task gets replenishment of its budget for that period and its priority is raised to its rate-monotonic priority. Another reason for a rescheduling operation may be a task that, while executing, exhausts its budget. For such a task, the budget scheduler lowers the priority to the background priority. Yet another reason for a rescheduling operation may be a task that finishes its processing within its budget and now releases the processor. Now the budget scheduler also lowers the priority of this task to the background priority. Once entered, process step 104 may need to perform multiple rescheduling operations, for multiple tasks. Next, after all necessary rescheduling operations have been performed the task with the highest priority gets selected in process step 106 and is scheduled for processing on the processor.

In decision step 108, the budget scheduler detects the need for rescheduling operations by means of rescheduling events. A rescheduling event signals that rescheduling operations may be required. One kind of rescheduling event relates to a task that finishes its processing and releases the processor. Other kinds of rescheduling events relate to budget replenishment and budget exhaustion. These budget-related events ensue from earlier rescheduling operations performed as part of process step 104. In the present embodiment, these budget-related rescheduling events are realized by means of a low-level timer service available from the real-time kernel used. This is not further shown here.

In decision step 110, the budget scheduler determines whether a budget surplus can be reallocated. In this step, it checks to see if the task last run has finished its processing within the budget, giving rise to a budget surplus, and whether such a budget then needs to be reallocated to another task. For example, in the case of the tasks τₘ and τₚ introduced above, if task τₘ finishes its processing within its budget, decision block 108 may decide to reallocate the remaining budget from task τₘ to task τₚ. If a budget surplus can be reallocated, this reallocation starts with process step 112, in which the budget scheduler saves the value of the currently remaining budget for the task that is to receive the budget surplus. The budget scheduler also saves the priority of the receiving task. In the case of task τₚ this would be priority p₃. Next, the actual reallocation occurs in process step 114. Here the task that is to receive the budget surplus actually gets assigned this budget, together with the priority of the task that provides the budget surplus. In the case of the tasks τₘ and τₚ, here the priority of task τₚ is set to p₁, being the priority of task τₘ. Processing continues with process step 104.

If a budget surplus is not available or reallocation is not needed, decision step 116 checks if the task last run did so using a budget surplus for which reallocation should end. A reallocation of a budget surplus to the task last run ends if the budget surplus gets exhausted or the task has finished its processing. If indeed the reallocation should end, in process step 118, the budget and priority values earlier saved for this task in process step 112 are now restored. Thus, in the case of task τₚ, the priority is restored to priority p₃ here. Processing continues with process step 104. This is also the case if in decision step 116 the task last run did not do so using a budget surplus for which reallocation should end.

The order of steps in the present embodiment is not mandatory. A person skilled in the art may change the order of steps or performs steps concurrently, for example by using threading models, multi-processor systems or multiple processes, without departing from the concept as intended by the current invention.

In the present embodiment, the reallocation is performed for a single budget surplus from one task to another task. In other embodiments, the reallocation could be performed for multiple budget surpluses originating from multiple tasks and being reallocated to multiple tasks. For example, a budget surplus from one task could be reallocated to multiple other tasks, or one task could receive budget surpluses from multiple other tasks. Also embodiments in which any unused parts of budget surpluses are once more reallocated are conceivable. Those skilled in the art will recognize such possibilities.

In the present embodiment, tasks are described as singular entities, with a budget, a budget period, and a priority. In other embodiments, such a task could actually represent a cluster of tasks, together sharing a single budget and a single budget period, but occupying a band of priorities so that the individual tasks within the cluster can be prioritized. Those skilled in the art will recognize such possibilities.

In the present embodiment, the budget scheduler uses fixed priority scheduling as the basic scheduling algorithm. In other embodiments, dynamic priority scheduling or mixed priority scheduling could be used. Those skilled in the art will recognize such possibilities.

FIG. 2 and FIG. 3 together illustrate the reallocation of a budget surplus. FIG. 2 shows a task interaction diagram and FIG. 3 a related priority level diagram. Basically, a task interaction diagram shows the execution of tasks over time. The tasks concerned are indicated on the vertical axis, and time runs on the horizontal axis. For each task, the diagram contains a timeline with indications for the status or status changes of that task. Also interactions between tasks can be shown. For the normal case, without budget surplus reallocations, indications include: budget enabling (also called replenishment), and indicated by a solid up-arrow, budget disabling, indicated by a solid down-arrow, and executing, that is consuming budget, indicated by a solid or shaded rectangle. To specifically indicate budget surplus reallocations, the following indications are also used: surplus enabling, indicated by an open up-arrow, surplus disabling, indicated by an open down-arrow, and the budget remainder being reallocated, indicated by a dotted rectangle. The diagram of FIG. 2 shows the execution of three tasks, τₘ, τₐ, and τₚ. These tasks have budgets of 5, 3, and 1 units of time, and budget periods of 10, 11, and 12 units of time respectively. Furthermore, task τₚ is to receive any budget surplus from task τₘ.

Scheduling is done with a pre-emptive fixed priority-based scheduling algorithm and a rate-monotonic priority assignment based on the budget periods. For the tasks τₘ, τₐ, and τₚ, this results in the priorities p₁, p₂, and p₃ for in-budget execution, where p₁>p₂>p₃. These priorities are shown on the vertical axis of the priority level diagram of FIG. 3. By means of a different line for each task, this diagram shows how the priority of each task changes over time. The lines 302, 304, and 306 represent the priorities of tasks τₘ, τₐ, and τₚ respectively. The top of FIG. 3 shows which one of the tasks τₘ, τₐ, and τₚ has the highest priority at any time, and is consequently executing at that time. For all of the three tasks, out-of-budget execution is possible at a low, background priority p_{b}, also shown in FIG. 3.

At time t=0, all of the three tasks enter a new budget period and receive a replenishment of their budget, indicated by solid up-arrows 202, 204, and 206. As a result of this, the tasks τₘ, τₐ, and τₚ, get assigned their in-budget priorities p₁, p₂, and p₃, respectively. Because τₘ has the highest priority, p₁, it is scheduled for execution on the processor.

At time t=3, task τₘ finishes processing for this budget period, after consuming only 3 of the 5 available budget units, indicated by rectangle 208. As a result, its budget is disabled, indicated by solid down-arrow 210, and its priority lowered from priority p₁ to the background priority p_{b}. This leaves a budget remainder of 2 units, indicated by rectangle 212. Since a budget remainder of task τₘ is to be reallocated to task τₚ, reallocation is enabled for task τₚ at time t=3, indicated by open up-arrow 214. Thus, task τₚ receives a budget surplus of 2 units. Together with this budget, surplus task τₚ receives the in-budget priority p₁ of task τₘ. Still at time t=3, this results in a priority raise for task τₚ, from priority p₃ to priority p₁, as shown in FIG. 3. Now task τₚ has the highest priority, p₁, and starts executing, consuming the budget surplus, indicated by rectangle 216.

At time t=5, task τₚ exhausts the budget surplus, after consuming 2 budget units, indicated by rectangle 216. As a result, the reallocation is disabled, indicated by open down-arrow 218. Because of this disabling, task τₚ reverts to the budget and priority it had before the reallocation took place. Thus, at time t=5, the priority of task τₚ is lowered from priority p₁ back to priority p₃, as shown in FIG. 3. Now, task τₚ is also no longer the task with the highest priority, as this is now task τₐ with priority p₂. Consequently, task τₐ gets scheduled and starts consuming its budget, indicated by rectangle 220.

At time t=8, when task τₐ exhausts its budget of 3 units, indicated by rectangle 220, its budget is disabled, indicated by solid down-arrow 222, and its priority lowered from priority p₂ to priority p_{b}. Now, task τₚ is once more the task with the highest priority. Thus, at time t=8 task τₚ is scheduled again, and for the first time starts consuming its own budget, indicated by rectangle 224.

At time t=9, when task τₚ exhausts its budget of 1 unit, indicated by rectangle 224, its budget is disabled, indicated by solid down-arrow 226, and its priority lowered from priority p₁ to priority p_{b}. Now, all of the three tasks are scheduled at the background priority p_{b}, possibly consuming some of the slack time, indicated by rectangle 228.

At time t=10, task τₘ enters a new budget period and receives a replenishment of its budget, indicated by solid up-arrow 230. As a result of this, task τₘ gets assigned its in-budget priority p₁ again, and starts executing with a new budget. Later, at time t=11 and time t=12, the new budget periods of tasks τₐ and τₚ start, with the corresponding replenishments, indicated by solid up-arrow 232 and 234.

FIG. 4 illustrates, in a schematic way, the most important parts of an embodiment of the system according to the invention. The system 400 comprises a first allocation unit 402, programmed to allocate a first budget to a first task. A second allocation unit 404 is programmed to allocate a second budget to a second task. There may be more allocation units, programmed to allocate budgets to other tasks. A scheduling unit 406 enforces the budgets of all tasks. Part of the scheduling unit 406 is a detection unit 408, programmed to detect that the first task uses up only part of the first budget. If this is the case, a budget surplus memory 410 contains the remaining part of the first budget. A reallocation unit 412 is used to reallocate the budget surplus to the second task. Part of the reallocation unit 412 is a third allocation unit 414, programmed to allocate the budget surplus held in budget surplus memory 410 to the second task, together with scheduling characteristics of the first task. This system can be realized in software intended to be operated as an application by a computer or any other standard architecture able to operate software. The system can be used to operate a digital television set 416.

FIG. 5 illustrates, in a schematic way, the most important parts of a television set 500 that comprises an embodiment of the system according to the invention. Here an antenna 502 receives a television signal. The antenna may also be, for example, a satellite dish, cable or any other device able to receive a television signal. A receiver 504 receives the signal. Besides the receiver 504, the television set 500 comprises a programmable component 506, for example a programmable integrated circuit. This programmable component 506 comprises a system according to the invention 508 such as the system described with reference to FIG. 4. A television screen 510 shows images that are received by the receiver 504 and are processed by the programmable component 506, the system according to the invention 508 and other parts that are normally comprised in a television set, but are not shown here.

FIG. 6 illustrates, in a schematic way, the most important parts of a set-top box 600 that comprises an embodiment of the system according to the invention. Here an antenna 602 receives a television signal. The antenna may also be, for example, a satellite dish, cable or any other device able to receive a television signal. A set-top box 600 receives the signal. Besides the normal parts that are comprised in a set-top box, but are not shown here, the set-top box 600 comprises a system according to the invention 604 such as the system described with reference to FIG. 4. The television set 606 can show the output signal generated by the set-top box 602 together with the system according to the invention 604 from a received signal.

The invention can be summarized as follows.

Media processing in software can be used for consumer terminals like digital television sets or set-top boxes. For reasons of cost-effectiveness, the average processor utilization must be high. This is mostly achieved by allocating below worst-case processor budgets to tasks performing media processing operations. Only if a stable output quality is a primary requirement, a task gets allocated a worst-case processor budget. To gain back on the cost-effectiveness in such a situation, a method and a system are provided to reallocate an unused part of a budget (212) from a first task (τₘ) with a worst-case budget to a second task (τₚ) with a below worst-case budget. The second task (τₚ) may then use the resulting budget surplus (216) to improve the quality of its output. The method and system operate at a very low level, in the scheduling of the tasks performing the media processing. What effectively happens is that the second task (τₚ) gets executed in the place of the first task (τₘ), as if it were the first task (τₘ), with scheduling characteristics such as period and priority of the first task (τₘ).

1. A method of scheduling a first task and a second task, the method comprising the following steps:
a first step of allocating a first budget to the first task,
a second step of allocating a second budget to the second task,
a third step of determining that the first task uses up only part of the first budget, with the remaining part of the first budget giving rise to a budget surplus,
a fourth step of reallocating the budget surplus to the second task, in addition to the second budget,
characterized in that the fourth step comprises a sub-step of:
allocating the budget surplus to the second task together with scheduling characteristics of the first task.

2. A method according to claim 1, wherein a fixed priority based scheduling algorithm is applied and said scheduling characteristics correspond to a period and a priority of the first task.

3. A method according to claim 1, wherein a deadline driven based scheduling algorithm is applied and said scheduling characteristics correspond to a period and a deadline of the first task.

4. A system (400) for scheduling a first task and a second task, the system comprising:
first allocation means (402) conceived to allocate a first budget to the first task,
second allocation means (404) conceived to allocate a second budget to the second task,
determination means (408) conceived to determine that the first task uses up only part of the first budget, with the remaining part of the first budget giving rise to a budget surplus,
reallocation means (412) conceived to reallocate the budget surplus to the second task, in addition to the second budget,
characterized in that the reallocation means comprises:
third allocation means (414) conceived to allocate the budget surplus to the second task together with scheduling characteristics of the first task.

5. A television set (500) comprising a system according to claim 4.

6. A set-top box (600) comprising a system according to claim 4.
